(19) United States
(12) Patent Application Publication
(10) Pub. No.: US 2008/0102700 A1
(43) Pub. Date: May 1, 2008

(54) Printed Circuit Board Connectors and Methods of Manufacturing the Same

(76) Inventors: Brian S. Beaman, Apex, NC (US); Joseph Kuczynski, Rochester, MN (US); Amanda E. Mikhail, Rochester, MN (US)

Correspondence Address: IBM Corporation;Intellectual Property Law Dept. 917, 3605 Hwy. 52 North, Rochester, MN, 55901, US

(21) Appl. No.: 11/553,498

(22) Filed: Oct. 27, 2006

(51) Int. Cl. H01R 13/648

(52) U.S. Cl. 439/608

(57) ABSTRACT

In a first aspect, a first method of manufacturing a connector for a printed circuit board (PCB) is provided. The first method includes the steps of (1) forming a housing for the connector using a material having first properties; and (2) before the housing is coupled to the PCB, annealing the connector housing to change the first properties of the material such that, after the connector is coupled to the PCB using a reflow process, warpage of a resulting connector-PCB assembly is within a predetermined tolerance. Numerous other aspects are provided.

### FIELD OF THE INVENTION

The present invention relates generally to computer systems, and more particularly to printed circuit board connectors and methods of manufacturing the same.

### BACKGROUND

A conventional computer system may include a first printed circuit board (PCB) or card (e.g., a motherboard). A second, smaller card (cardlet) (e.g., a dual in-line memory module (DIMM)), which includes an integrated circuit, may be coupled to the first card. The first card may be formed from a first material having a first coefficient of thermal expansion (CTE), which, when combined with temperature ramp (e.g., a change in temperature over time), determines a rate at which the first material expands when heated (and thereafter shrinks when cooled).

A connector may be employed to couple the second card to the first card. The connector generally is a large one-piece housing that is formed from a thermoplastic resin having a second CTE. The connector includes leads adapted to electrically couple the housing to corresponding pads of the first card. Further, the connector includes features adapted to electrically couple to corresponding features of the second card. In this manner, when the second card is inserted into the connector, the second card is electrically coupled to the first card.

To couple the connector to the first card, a solder paste may be applied to the first card (e.g., to the pads of the first card) and the connector may be placed on the first card such that the connector leads align with the pads of the first card. Thereafter, the solder paste may be reflowed and solidified such that solder fixedly and electrically couples the leads to the pads, respectively. The card assembly (e.g., the first card and connector) is heated to a high temperature to reflow the solder paste.

During the process to couple the connector to the first card, the connector may expand. More specifically, due to the coefficient of thermal expansion of the connector, the connector may expand while the solder paste is reflowed. Further, while the solder solidifies, the connector may shrink. However, due to properties of the connector housing material, the connector may not shrink to its original size but rather to a size larger than the original size. Because the connector is fixedly coupled to the card, the mismatch in final size to original size of the connector causes warpage of the card. Further, the CTE of the first card may be significantly different than the CTE of the connector. Such a difference between the CTEs, coupled with the cooling rate, may cause the first card to shrink much faster than the connector, and therefore, contributes to the card assembly warpage.

Card assembly warpage may cause excessive strain on joints between the first card and the connector. Even worse, due to card assembly warpage, the features of the connector may no longer align with corresponding features on the second card and/or the connector leads may no longer align with corresponding pads on the first card. Accordingly, improved connectors and card assemblies, and methods of manufacturing the same are desired.

### SUMMARY OF THE INVENTION

In a first aspect of the invention, a first method of manufacturing a connector for a printed circuit board (PCB) is provided. The first method includes the steps of (1) forming a housing for the connector using a material having first properties; and (2) before the housing is coupled to the PCB, annealing the connector housing to change the first properties of the material such that, after the connector is coupled to the PCB using a reflow process, warpage of a resulting connector-PCB assembly is within a predetermined tolerance.

In a second aspect of the invention, a first apparatus is provided. The first apparatus is a connector for a printed circuit board (PCB) that includes (1) a housing formed from a material having first properties which have been changed by annealing the housing before the housing is coupled to the PCB such that, after the connector is coupled to the PCB using a reflow process, warpage of a resulting connector-PCB assembly is within a predetermined tolerance; (2) first connector features adapted to couple the connector to the PCB; and (3) second connector features adapted to couple the connector to a smaller PCB supported by the connector.

In a third aspect of the invention, a first system is provided. The first system is a card assembly that includes (1) a printed circuit board (PCB); and (2) a connector coupled to the PCB. The connector includes (a) a housing formed from a material having first properties which have been changed by annealing the housing before the housing is coupled to the PCB such that, after the connector is coupled to the PCB using a reflow process, warpage of the resulting card assembly is within a predetermined tolerance; (b) first connector features that couple the connector to the PCB; and (c) second connector features adapted to couple the connector to a smaller PCB supported by the connector. Numerous other aspects are provided, as are systems and apparatus in accordance with these other aspects of the invention.

Other features and aspects of the present invention will become more fully apparent from the following detailed description, the appended claims and the accompanying drawings.

### BRIEF DESCRIPTION OF THE FIGURES

FIG. 1 is an isometric view of a conventional connector for a printed circuit board (PCB).

FIG. 2 is a front view of the conventional connector for a PCB.

FIG. 3 is a top view of the conventional connector for a PCB.

FIG. 4 is a side view of the conventional connector for a PCB.

FIG. 5 is a block diagram of a warped card assembly including a conventional connector.

FIG. 6 illustrates an improved connector housing in accordance with an embodiment of the present invention.

FIG. 7 illustrates an improved connector coupled to a PCB in accordance with an embodiment of the present invention.

FIG. 8 illustrates a method of manufacturing the improved connector for a PCB in accordance with an embodiment of the present invention.

### DETAILED DESCRIPTION

The present invention provides improved connectors and card assemblies, and methods of manufacturing the same. More specifically, a housing for a connector may be formed by injecting a material (e.g., thermoplastic and/or the like) into a mold. However, before coupling such connector to a PCB using reflow and solidification processes, the connector housing may undergo annealing at a high temperature for an extended amount of time (e.g., annealing at 250° C. for about four hours (although other annealing temperatures and/or times may be used)). Such annealing may favorably affect the CTE of the connector housing material and expansion of the connector housing during reflow and solidification employed to couple the connector to the PCB. For example, such CTE properties may be changed such that the card assembly warpage may be reduced to within an acceptable predetermined tolerance. After annealing, leads and features adapted to electrically couple to corresponding features of a second card may be formed on the connector housing. Alternatively, in some embodiments, the connector housing may undergo extensive annealing after such leads and features are formed on the housing. In this manner, the present invention may provide improved connectors and card assemblies, and methods of manufacturing the same.

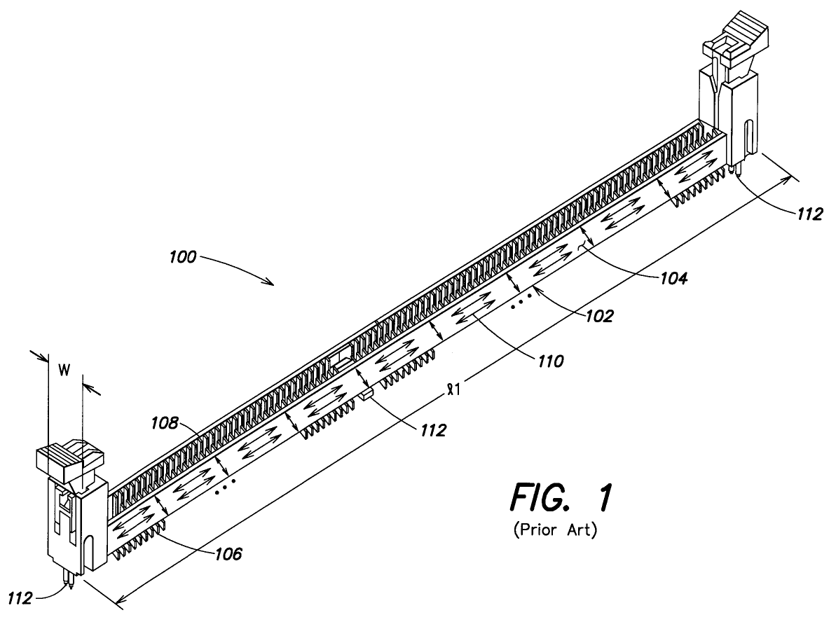

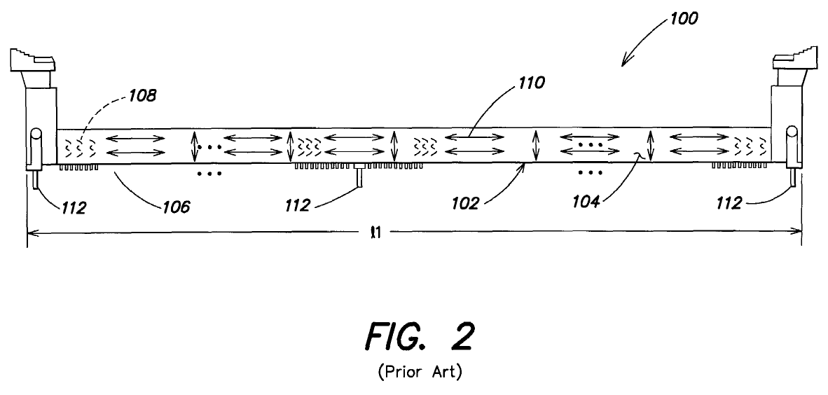

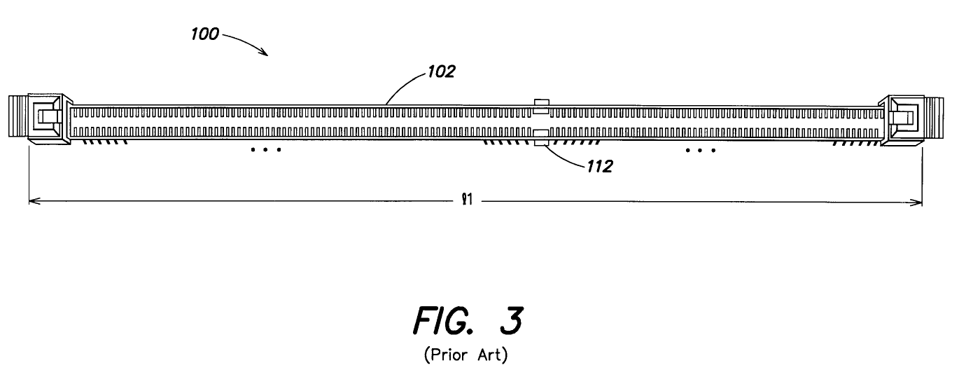

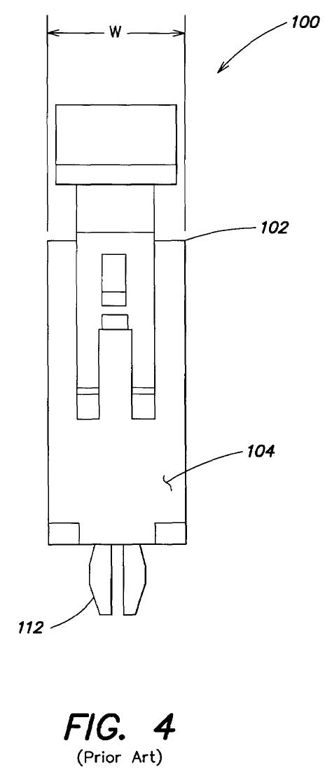

FIGS. 1-4 are respective isometric, front, top and side views of a conventional connector 100 for a printed circuit board (PCB). With reference to FIGS. 1-4, a housing 102 of the conventional connector or interconnect 100 may be formed by injecting one or more high temperature thermoplastic resin materials 104 into a mold. The conventional connector 100 may be large and monolithic. More specifically, the housing 100 may have a width w and a length 11 that is significantly longer than the width w. For example, the connector 100 may have a width w of about 4 mm to about 10 mm, and a length 11 of about 100 mm to about 150 mm. However, a larger or smaller width and/or length range may be employed. Further, the connector 100 may be a one-piece assembly (e.g., a non-segmented connector).

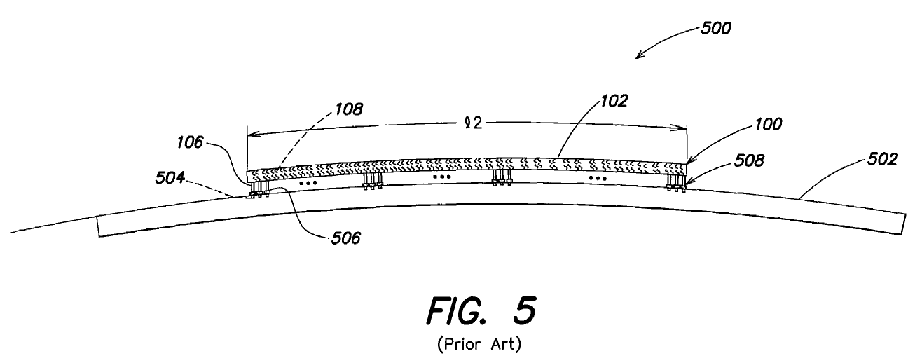

Features may be formed on the connector 100 such that the connector 100 may couple a small card (e.g., a cardlet or memory module) to a larger card (e.g., a motherboard). The connector 100 may be a surface mount connector. For example, leads 106 (not all leads shown), which are adapted to couple to corresponding features, such as pads (not shown in FIG. 1; 504 in FIG. 5) of the PCB, may be formed on the housing 100. Further, features 108 (e.g., pads or spring-type leads), which are adapted to couple to corresponding features of the cardlet or daughter card, may be formed on the housing 100. Thermoplastic material 104 employed to form the housing 102 may inherently include stresses 110. Further, additional stresses 110 may be introduced in the material while manufacturing (e.g., injecting the material in a mold lengthwise) the housing 102. Thus, such material 104, and therefore, the connector 100 formed thereby, may have first mechanical and/or material properties. Such material may have one or more coefficients of thermal expansion. For example, the connector 100 may have a first coefficient of thermal expansion CTE_{CONNECTOR LENGTH} that indicates change in connector size in a first direction (e.g., lengthwise) based on a temperature change. Further, the connector 100 may have a second coefficient of thermal expansion CTE_{CONNECTOR WIDTH} that indicates change in connector size in a second direction (e.g., widthwise) based on the temperature change. The housing 102 may be formed to include small geometries (e.g., 0.5 mm with wall sections). Consequently, the CTEs CTE_{CONNECTOR LENGTH,} CTE_{CONNECTOR WIDTH} of the connector 100 may be significantly smaller than that of a block of such material 104 that does not include such geometries. Further, the CTEs CTE_{CONNECTOR LENGTH,} CTE_{CONNECTOR WIDTH} of the connector 100 may be significantly smaller than that of the PCB CTE_{PCB}.

Further, the connector 100 may be expected to expand by a certain amount when heated, and thereafter, expected to shrink by a certain amount when cooled. The conventional connector 100 has been demonstrated to shrink less than the connector 100 expands, which results in warping (described below). Thus, the connector housing material 104 may be dimensionally unstable (e.g., in a direction of flow in the mold).

In some embodiments, the connector 100 may include features 112, such as fork locks or board locks. Such features 112 may be adapted to stably connect the connector 100 to a PCB during a reflow process.

FIG. 5 is a block diagram of a warped card assembly 500 including a conventional connector 100. With reference to FIG. 5, the card assembly 500 includes the connector 100 of FIG. 1 coupled (e.g., fixedly) to a PCB 502. The PCB 502 may include insulator material (e.g., Flame Resistant 4 (FR-4) epoxy) and electrically-conductive material (e.g., copper planes and traces). Thus, the PCB 502 may have second mechanical and/or material properties. For example, the PCB 502 may have one or more coefficients of thermal expansion CTE_{PCB} that indicates change in PCB size (e.g., in a direction) based on a temperature change. Further, the PCB 502 may be expected to expand by a certain amount when heated, and thereafter, expected to shrink by a certain amount when cooled.

To couple the connector 100 to the PCB 502, a solder paste may be applied to features 504 (e.g., pads) of the PCB 502 that correspond to the connector leads 106. The leads 106 of the connector 100 may be aligned with and coupled to the corresponding features 504 of the PCB 502. Thereafter, the card assembly 500 may undergo a reflow process during which the card assembly 500 is heated such that the solder paste melts. As the melted solder paste cools and solidifies, the connector leads 106 are coupled to the PCB features 504, respectively. In this manner, at room temperature, solder 506 may fixedly and electrically couple the connector leads 106 to the corresponding PCB features 504

Based on the connector and PCB properties, when the connector 100 is coupled to PCB 502 using the reflow/solidification processes, the card assembly 500 may warp. For example, the heat employed during the reflow process causes the connector 100 (e.g., housing 102 thereof) to expand by expected amounts (e.g., lengthwise and/or widthwise) at rates determined by the one or more connector CTES: CTE_{CONNECTOR LENGTH,} CTE_{CONNECTOR WIDTH,} as well as the prescribed temperature ramp. The connector housing 102 may often grow along the length of the connector (e.g., dependent on material flow when molding the housing 102). Similarly, the heat employed during the reflow process causes the PCB 502 to expand by expected amounts at rates determine by the one or more PCB CTES, CTE_{PCB}, as well as the prescribed temperature ramp.

As the card assembly 500 cools, the connector 100 and PCB 502 may shrink. However, the connector 100 and/or PCB 502 may not shrink to their respective original sizes. For example, the PCB 502 may shrink to its original length and the connector 100, which is now fixedly coupled to the PCB 502, may shrink to a length 12 that is greater than the original connector length 11. Consequently, the connector 100 and/or PCB 502 may warp beyond an acceptable predetermined tolerance. The difference between CTEs of the connector 100 and PCB 502 may further exacerbate the warping. For example, the PCB 502 may shrink faster than the connector 100 as the card and connector assembly cool to room temperature after solder reflow and solidification.

Such card assembly warping may displace one or more of the features (e.g., spring-type leads or pads) 108 of the connector 100 that form a separable contact interface from their respective true positions. Additionally or alternatively, the card assembly warping may displace one or more of the connector leads 106 from their respective true positions. Consequently, the warping may strain joints 508 formed by the interface of the connector leads 106, PCB pads 504, and solder 506, respectively. Such strain may result in creep and/or eventual fatigue failure of card assembly components (e.g., surface mount technology (SMT) joints).

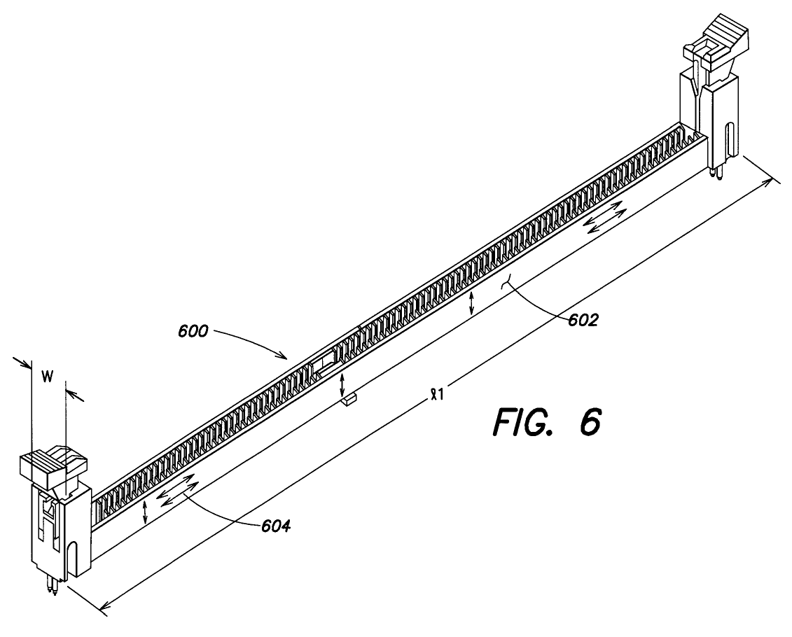

FIG. 6 illustrates an improved connector housing 600 in accordance with an embodiment of the present invention. With reference to FIG. 6, the improved connector housing 600 may be similar to the housing 102 of the conventional connector 100. For example, the improved connector housing 600 may be formed by injecting one or more high-temperature thermoplastic resin materials 602 into a mold. Thus, the materials 602 employed to form the improved connector housing 600 may include inherent stresses and additional stresses introduced in the material 602 while manufacturing the improved housing 600. However, the improved connector housing 600 may be formed from a larger or smaller number of materials and/or different materials. For example, in some embodiments, the improved connector housing 600 may be formed from a blend of one or more LCPs and polyphenylene sulfide (PPS). The improved connector housing 600 may have the same dimensions (e.g., length 11 and width w) as the conventional connector housing 102. However, in some embodiments, the improved connector housing 600 may be shaped and/or dimensioned differently. Further, the improved connector housing 600 may be large and monolithic.

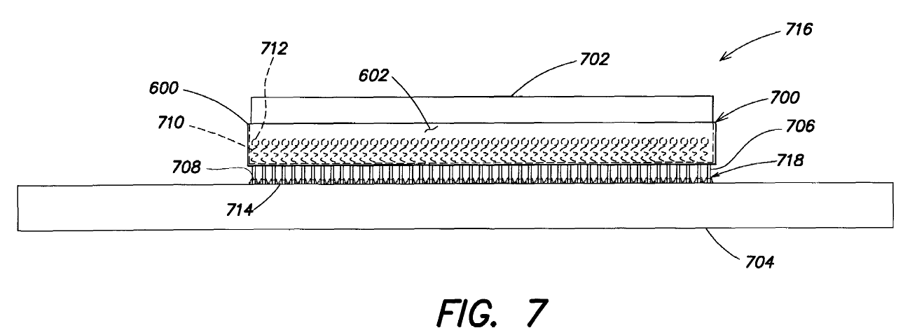

Regardless of whether the improved connector housing 600 is similar to the conventional connector housing 102, when formed, the improved connector housing material 602 may retain an initial amount of stresses. Therefore, the improved connector housing material 602 may have initial properties (e.g., mechanical and/or material properties). For example, the improved connector housing material 602 may have an initial expected expansion (e.g., elongation) value and one or more initial CTEs, such as CTE_{IMPROVEDCONNECTOR LENGTH1}, CTE_{IMPROVEDCONNECTOR WIDTH1}. Therefore, the housing material 602 with the initial properties may be dimensionally unstable during processing, such as reflow and solidification. In contrast to the conventional connector housing 102, the improved connector housing 600 may be processed such that the initial amount of stresses (e.g., inherently in the material 602 and introduced therein during molding) may be reduced. The properties of the material 602 may be based on the resulting stresses 604. In this manner, the initial properties of the material 602 may be changed. For example, the expected expansion of the improved connector housing material 602 during reflow and solidification may be reduced. Additionally or alternatively, one or more initial CTEs of the improved connector housing material 602, CTE_{IMPROVEDCONNECTOR LENGTH1}, CTE_{IMPROVEDCONNECTOR WIDTH1} may be increased. In this manner, a difference between the increased CTEs, CTE_{IMPROVEDCONNECTOR LENGTH2}, CTE_{IMPROVEDCONNECTOR WIDTH2} of the improved connector housing material 602 and corresponding CTEs of a PCB, CTE_{PCB}, to which the improved housing 600 attaches may be reduced. By changing the properties (e.g., expected expansion and one or more CTEs) of the improved connector housing material 602 in this manner, when reflow and solidification processes are employed to couple a connector (700 in FIG. 7) including the improved housing 600 to a PCB (704 in FIG. 7), warping of the connector 700 and/or PCB 704 may be reduced.

FIG. 7 illustrates the improved connector 700 coupled to a PCB in accordance with an embodiment of the present invention. With reference to FIG. 7, in contrast to the conventional connector 100, the improved connector 700 may include the improved housing 600. Otherwise, the improved connector 700 may be similar to the conventional connector 100. For example, features may be formed on the connector 700 such that the connector 700 may couple a small card (e.g., a cardlet or daughter card) 702 to a larger card (e.g., motherboard) 704. Leads 706, which are adapted to couple to corresponding features (e.g., pads) 708 of the PCB 704, may be formed on the housing 600. Further, connector features (e.g., spring-like leads or pads) 710, which are adapted to couple to corresponding features (e.g., pads) 712 of the small card 702, may be formed on the housing 700.

In a similar manner to the conventional connector 100, a reflow/solidification process may be employed to fixedly couple the improved connector 700 to the PCB 704. Thus, solder 714 may fixedly couple connector leads 706 to corresponding features 708 of the PCB 704, respectively.

However, because the initial properties of the housing material 602 have changed (e.g., the expected expansion of the material 602 may be reduced and/or one or more CTEs of the material 602 may be increased), if the card assembly 716 warps during the reflow/solidification process, such warping may be within an acceptable predetermined tolerance. Therefore, the PCB 704 may be substantially flat and/or the connector 700 may be substantially straight after the reflow/solidification process. Consequently, the resulting card assembly 716 may avoid disadvantages of the conventional card assembly 500 described above. Thus, card assembly warping may not displace one or more of the features 710 of the connector 700 from their respective true positions beyond an acceptable predetermined tolerance. In this manner, after the reflow/solidification process, such connector features 710 may still align with corresponding features 712 of the small card 702.

Additionally or alternatively, the card assembly warping may not displace one or more of the connector leads 706 from their respective true positions beyond an acceptable predetermined tolerance. In this manner, after the reflow/solidification process, the connector leads 706 may still align with corresponding features 708 of the PCB 704. Consequently, the warping may not strain joints 718 formed by the interface of the connector leads 706, PCB pads 708 and solder 714, respectively, enough to cause creep and/or fatigue failure of the card assembly components.

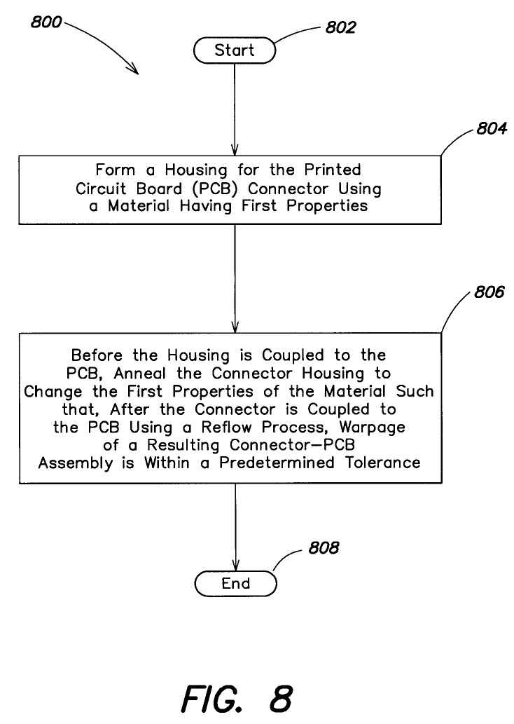

FIG. 8 illustrates a method of manufacturing the improved connector 700 for a PCB 704 in accordance with an embodiment of the present invention. With reference to FIG. 8, in step 802, the method 800 begins. In step 804, a housing 600 for the connector 700 is formed using a material 602 having first properties. For example, the material 602 may include one or more LCPs, a blend of LCPs and PPS, a blend of LCP and nylon, an LCP with glass fibers, or another suitable material. To form a housing 600 of a desired geometry, the material 602 may be injected into an appropriate mold. As stated, the housing material 602 may inherently include stresses, and additional stresses may be introduced in the material 602 during molding. Therefore, when molded, the material 602 in the housing 600 may have initial properties.

In step 806, before the housing 600 is coupled to the PCB 704, the connector housing 600 is annealed to change properties of the material 602 such that, after the connector 700 is coupled to the PCB 704 using the reflow and solidification processes, warpage of a resulting connector-PCB assembly is within a predetermined tolerance. During annealing, the housing 700 may be exposed to a temperature of about 200 to about 400° C. for about 0.5 to about 8.0 hours. For example, the housing 600 may be exposed to a temperature of 250° C. for about four hours. However, a larger or smaller and/or different temperature range and/or time range may be employed. A connector manufacturer may anneal the housing material 602 in this manner. Such annealing may relieve the inherent stresses in the housing material 602 and/or stresses introduced to the material 602 when forming the housing 600. Consequently, after annealing, the material 602 may have second, changed properties. For example, the expected expansion of the material 602 after the reflow and solidification processes may be reduced and/or one or more CTES, CTE_{IMPROVEDCONNECTOR LENGTH}, CTE_{IMPROVEDCONNECTOR WIDTH} of the material 602 may be increased. Although a single anneal is described above, in some embodiments, the connector housing may undergo a series of annealing steps.

Thereafter, the leads 706 and connector features 710 adapted to couple to corresponding features 712 of the small card 702 may be formed on the housing 600. Alternatively, in some embodiments, the leads 706 and features 710 may be formed on the housing 600 before the housing 600 is annealed to change properties of the material 602. Therefore, a card assembly manufacturer may anneal the connector housing material 602 to change the properties thereof.

The second, changed properties of the housing material 602 may reduce and/or eliminate warping of the card assembly 716 during the reflow/solidification process employed to fixedly couple the connector 700 to the PCB 704. In this manner, such warping is within a predetermined tolerance. For example, the changed properties of the housing material 602 cause the housing 600 to expand and contract less during the reflow/solidification process than such material 602 with the initial properties so that the final dimension of the housing material 602 after reflow/solidification more closely matches that of the housing material 602 before reflow/solidification. Further, the increased CTEs of the annealed housing material 602 may be closer to the CTE of the PCB 704 than such material 602 before annealing. Therefore, the rate at which the annealed housing material 602 expands/contracts may be closer to that of the PCB (compared to the material 602 before annealing). In this manner, the present invention provides a connector for a card assembly 700 that may reduce warping of the assembly during the reflow/solidification process employed to fixedly and electrically couple the connector 700 to a PCB 704.

Thereafter, step 808 may be performed. In step 808, the method of FIG. 8 ends.

Through use of the method of FIG. 8, an improved connector 700 may be manufactured which reduces warping when the connector 700 and PCB 704 are assembled (e.g., electrically or fixedly coupled) to form a card assembly 716. To manufacture the improved connector 700, a connector housing 600 may be formed from thermoplastic and/or other suitable materials. Once formed, a connector housing 600 may undergo extensive annealing. In this manner, the connector housing material 602 may be exposed to an elevated temperature for an extensive amount of time. Such annealing of the connector housing material 602 may alter (e.g., increase) one or more CTEs of the material 602, as well as impact (e.g., reduce significantly) the expected expansion of the housing 700 through the reflow/solidification cycle. Altering one or more CTEs and the expected expansion in this manner may reduce warping of the card assembly 716 such that the warping is within normal and acceptable limits. Consequently, card assembly 716 yields may be improved.

Thus, the present invention provides a low-cost, low-risk method that employs industry-standard connector housing materials 602 and molds to reduce connector warping such that positional impact on mating components of the connector 700 and/or PCB 704 are reduced. Further, such methods may be employed to form connectors 700 having large, monolithic housings 600 that may not negatively impact PCB flatness or strain on joints between the connector 700 and the PCB 704 when the connector 700 is coupled to the PCB 704. Consequently, the present methods, apparatus and systems may reduce card assembly warping without requiring mechanical modification (e.g., dividing the connector into segments with gaps therebetween to allow for expansion) or fixturing (e.g., banding edges of the connector with copper and/or the like) of the connector to flatten the card assembly. Avoiding such mechanical modification and/or fixturing is beneficial because, depending on the reliability criteria of the card assembly, mechanical modification and/or fixturing may induce other stresses to the solder joints of the assembly, which negatively impact overall reliability thereof. Further, mechanical modification to the connector housing may impact an already-established industry standard.

The foregoing description discloses only exemplary embodiments of the invention. Modifications of the above disclosed apparatus and methods which fall within the scope of the invention will be readily apparent to those of ordinary skill in the art. For instance, although a connector 700 which employs surface mount technology to couple to a PCB 704 is described above, the present methods, apparatus and systems may include connectors that employ a different type of technology, such as pin-through-hole, to couple to the PCB 704. As described above, the present methods and apparatus may be useful to reduce warping of large, monolithic connectors 700. However, in some embodiments, the present methods may be employed for different types of connectors (e.g., smaller and/or segmented connectors.)

Accordingly, while the present invention has been disclosed in connection with exemplary embodiments thereof, it should be understood that other embodiments may fall within the spirit and scope of the invention, as defined by the following claims.

The invention claimed is:

1. A method of manufacturing a connector for a printed circuit board (PCB), comprising:
forming a housing for the connector using a material having first properties; and
before the housing is coupled to the PCB, annealing the connector housing to change the first properties of the material such that, after the connector is coupled to the PCB using a reflow process, warpage of a resulting connector-PCB assembly is within a predetermined tolerance.

2. The method of claim 1 wherein annealing the connector housing to change the first properties of the material includes annealing the connector housing at a temperature of about 200° C. to about 400° C. for about 0.5 to about 8.0 hours.

3. The method of claim 1 wherein annealing the connector housing to change the first properties of the material such that, after the connector is coupled to the PCB using a reflow process, warpage of the resulting connector-PCB assembly is within the predetermined tolerance includes relieving stresses caused in the material when forming the connector housing.

4. The method of claim 1 wherein annealing the connector housing to change the first properties of the material such that, after the connector is coupled to the PCB using a reflow process, warpage of the resulting connector-PCB assembly is within the predetermined tolerance includes changing a coefficient of thermal expansion of the connector housing.

5. The method of claim 1 wherein annealing the connector housing to change the first properties of the material such that, after the connector is coupled to the PCB using a reflow process, warpage of the resulting connector-PCB assembly is within the predetermined tolerance includes reducing potential expansion of the connector housing when the connector is coupled to the PCB using the reflow process.

6. The method of claim 1 further comprising, after annealing the connector housing, forming connector features adapted to couple the connector to the PCB and connector features adapted to couple the connector to a smaller PCB supported by the connector.

7. The method of claim 1 further comprising, before annealing the connector housing, forming connector features adapted to couple the connector to the PCB and connector features adapted to couple the connector to a smaller PCB supported by the connector.

8. A connector for a printed circuit board (PCB), comprising:
a housing formed from a material having first properties which have been changed by annealing the housing before the housing is coupled to the PCB such that, after the connector is coupled to the PCB using a reflow process, warpage of a resulting connector-PCB assembly is within a predetermined tolerance;
first connector features adapted to couple the connector to the PCB; and
second connector features adapted to couple the connector to a smaller PCB supported by the connector.

9. The connector of claim 8 wherein the annealing is performed at a temperature of about 200° C. to 400° C. for about 0.5 to about 8.0 hours.

10. The connector of claim 8 wherein stresses caused in the material when forming the housing are relieved by the annealing.

11. The connector of claim 8 wherein an original coefficient of thermal expansion of the material is changed by the annealing.

12. The connector of claim 8 wherein a potential expansion of the connector housing when the connector is coupled to the PCB using the reflow process is reduced by the annealing.

13. The connector of claim 8 wherein the first and second connector features are formed on the connector housing before the annealing.

14. The connector of claim 8 wherein the first and second connector features are formed on the connector housing after the annealing.

15. The connector of claim 8 wherein the material includes one or more thermoplastics.

16. The connector of claim 8 wherein the housing is a one-piece assembly having a length of about 100 to about 150 mm and a width of about 4 to about 10 mm.

17. A card assembly, comprising:
a printed circuit board (PCB); and
a connector coupled to the PCB and including:
a housing formed from a material having first properties which have been changed by annealing the housing before the housing is coupled to the PCB such that, after the connector is coupled to the PCB using a reflow process, warpage of the resulting card assembly is within a predetermined tolerance;
first connector features that couple the connector to the PCB; and
second connector features adapted to couple the connector to a smaller PCB supported by the connector.

18. The card assembly of claim 17 wherein the housing annealing is performed at a temperature of about 200° C. to 400° C. for about 0.5 to about 8.0 hours.

19. The card assembly of claim 17 wherein stresses caused in the material when forming the housing are relieved by the annealing.

20. The card assembly of claim 17 wherein an original coefficient of thermal expansion of the material is changed by the annealing.

21. The card assembly of claim 17 wherein a potential expansion of the connector housing when the connector is coupled to the PCB using the reflow process is reduced by the annealing.

22. The card assembly of claim 17 wherein the first and second connector features are formed on the connector housing before the annealing.

23. The card assembly of claim 17 wherein the first and second connector features are formed on the connector housing after the annealing.

24. The card assembly of claim 17 wherein the material includes one or more thermoplastics.

25. The card assembly of claim 17 wherein the housing is a one-piece assembly having a length of about 100 to about 150 mm and a width of about 4 to about 10 mm.
